(19) United States
(12) Patent Application Publication
(10) Pub. No.: US 2024/0241387 A1
(43) Pub. Date: Jul. 18, 2024

(54) HEAD-MOUNTED DEVICE AND AUGMENTED REALITY DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-PING TANG, Shenzhen (CN); CHENG-CHING CHIEN, New Taipei (TW)

(21) Appl. No.: 18/406,413

(22) Filed: Jan. 8, 2024

(30) Foreign Application Priority Data
Jan. 17, 2023 (CN) 202310090628.4

(51) Int. Cl. G02B 27/01; G02B 27/00

(52) U.S. Cl. CPC G02B 27/0179; G02B 27/0093; G02B 27/0172; G02B 27/0176; G02B 2027/0132; G02B 2027/0154; G02B 2027/0163; G02B 2027/0187

(57) ABSTRACT

A head-mounted device comprises a main body, a monitor-base, at least one monitor, and a sensor. The main body is mounted on a head. The monitor moves with the monitor-base. The sensor is mounted on the main body or the monitor-base and used for detecting a state of the head. A visual field is defined as a maximum area seen by eyes of the user, and an area of the virtual image is smaller than the visual field. The at least one monitor is movable by moving the monitor-base relative to the main body according to the state of the head, detected by the sensor, to adjust a relative angle of the monitor to the eyes such that a relative position of the virtual image in the visual field is adjusted, to ensure that the user sees the virtual image. An augmented reality device is also disclosed.

### FIELD

The disclosure herein generally relates to wearable display devices, and more particularly relates to a head-mounted device and an augmented reality device.

### BACKGROUND

Users can see a virtual image through a monitor of a head-mounted device, such as an augmented reality device. Usually, when the head of the user is stable, the maximum area seen by the eyes is the visual field, and the virtual image is smaller than the visual field, so that the eyes can see the entire virtual image. However, when the eyes rotate causing the sight of the eyes to fall into areas beyond the virtual image, the user cannot see the virtual image.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram view illustrating a head-mounted device wearable on a head according to an embodiment of the present disclosure.

FIG. 2 is a flow chart illustrating whether to rotate a monitor in the head-mounted device in FIG. 1.

FIG. 3 is a diagram view illustrating another embodiment of a head-mounted device wearable on a head according to an embodiment of the present disclosure.

FIG. 4 is a flow chart illustrating whether to rotate a monitor in the head-mounted device in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, baffle structures, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “comprising” means “including, but not necessarily limited to;” it specifically indicates open-ended inclusion or membership in a so-described combination, group, series, and the like.

Without a given definition otherwise, all terms used have the same meaning as commonly understood by those skilled in the art. The terms used herein in the description of the present disclosure are for the purpose of describing specific embodiments only, and are not intended to limit the present disclosure.

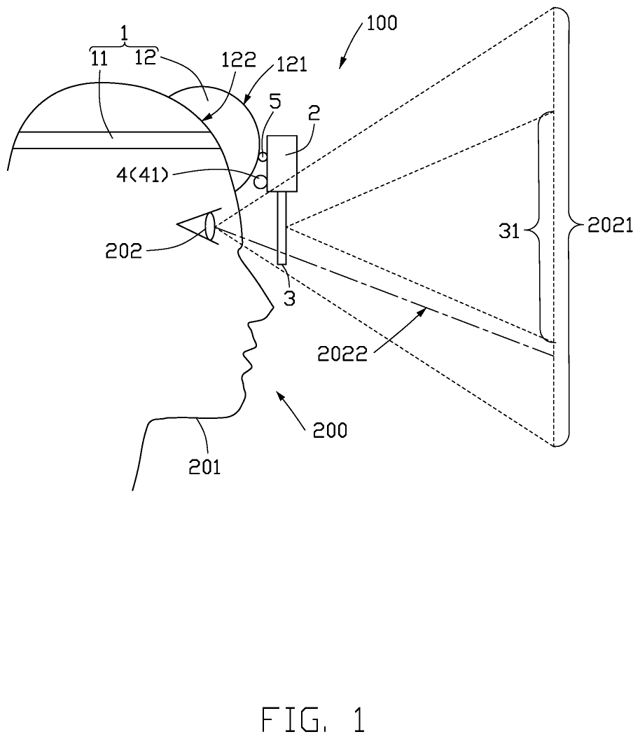

As shown in FIG. 1, a head-mounted device 100 in an embodiment includes a main body 1, a monitor-base 2, a monitor 3, and a sensor 4. The main body 1 can be worn over a head 201 of a user 200. The monitor-base 2 is movably mounted on the main body 1. The monitor 3 is mounted on the monitor-base 2. The monitor 3 can be moved with the monitor-base 2 relative to the main body 1. The monitor 3 is used for displaying a virtual image 31, and eyes 202 can see the virtual image 31 through the monitor 3. A visual field 2021 is defined as a maximum area seen by the eyes 202. An area of the virtual image 31 is smaller than the visual field 2021. The visual field 2021 is the maximum achievable visual area that the eyes 202 can see by turning. The sensor 4 is mounted on the main body 1 or on the monitor-base 2. The sensor 4 is used for detecting a state of the head 201. When the sensor 4 senses the state of the head 201 changed, the monitor-base 2 moves the monitor 3 to adjust a relative angle of the monitor 3 to the eyes 202, to adjust a relative position of the virtual image 31 in the visual field 2021, to guarantee the eyes 202 see the virtual image 31.

Because the main body 1 is fixed relative to the head 201, when the monitor-base 2 rotates relative to the main body 1, the monitor-base 2 drives the monitor 3 to rotate relative to the head 201, which can adjust a relative angle of the monitor 3 to the eyes 202, and finally adjust a relative position of the virtual image 31 in the visual field 2021. Since the monitor 3 is between the virtual image 31 and the eyes 202, a small adjustment of the monitor 3 can cause a large change in the position of the virtual image 31. After the sensor 4 senses the state of the head 201, the head-mounted device 100 compares the position where the sight 2022 of the eyes 202 locates in the visual field 2021 with the position of the virtual image 31 relative to the visual field 2021, and adjusts the relative angle of the monitor 3 to the eyes 202 if needed, to realize that the virtual image 31 locates in the sight 2022 of the eyes 202.

In some embodiments, the virtual image 31 includes, but is not limited to, AR (Augmented Reality) virtual image, VR (Virtual Reality) virtual image, or MR (Mixed Reality) virtual image.

In some embodiments, the angle of the virtual image 31 displayed by the monitor 3 relative to the monitor 3 is fixed.

In some embodiments, eyes 202 can see certain area outside the monitor 3, which means that the visual field 2021 is larger than the maximum area that the eyes 202 can see through the monitor 3. Also, the maximum area that the eyes 202 can see through the monitor 3 is larger than the virtual image 31, so some areas in the maximum area that the eyes 202 can see through the monitor 3 are not covered by the virtual image 31, but the movement of the monitor-base 2 can change the relative angle of the monitor 3 to the eyes 202, to adjust the position of virtual image 31 in the visual field 2021. In some other embodiments, eyes 202 can see certain area outside the monitor 3, the visual field 2021 is larger than the maximum area that the eyes 202 can see through the monitor 3, the virtual image 31 covers the whole area that the eyes 202 can see through the monitor 3, also, the movement of the monitor-base 2 can change the relative angle of the monitor 3 to the eyes 202, to adjust the position of virtual image 31 in the visual field 2021.

As shown in FIG. 1, in some embodiments, the head-mounted device 100 further includes a rotating shaft 5. The monitor-base 2 is connected to the main body 1 through the rotating shaft 5. The monitor-base 2 is rotatable relative to the main body 1, and the monitor-base 2 rotates to adjust the relative angle of the monitor 3 to the eyes 202. The monitor-base 2 can rotate around the rotating shaft 5 and thus rotate relative to the main body 1. Because the monitor 3 is fixed relative to the monitor-base 2, the monitor-base 2 drives the monitor 3 to rotate relative to the main body 1. Because the position of the main body 1 relative to the eyes 202 is fixed, the angle of the monitor 3 relative to the eyes 202 is changed to adjust the position of the virtual image 31 in the visual field 2021, so that the position of the virtual image 31 in the visual field 2021 locates on where the sight 2022 of the eyes 202 locates, allowing the user 200 to see the virtual image 31.

In some embodiments, the monitor-base 2 is fixedly connected to the rotating shaft 5. The rotating shaft 5 rotates to rotate the monitor-base 2. The rotating shaft 5 is an electric rotating shaft.

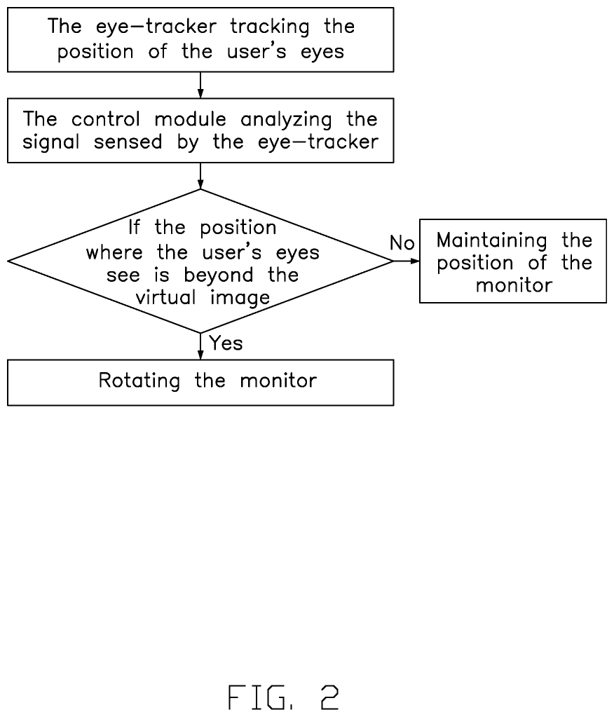

As shown in FIG. 1 to FIG. 2, in some embodiments, the sensor 4 senses the state of the head 201 by sensing the position of the eyes 202. The sensor 4 includes an eye-tracker 41. The eye-tracker 41 is mounted on the monitor-base 2. The eye-tracker 41 is used for tracking the position of the eyes 202 where the sight 2022 of the eyes 202 locates in the visual field 2021. When the eye-tracker 41 senses the place where the eyes 202 see is beyond the virtual image 31, the monitor-base 2 rotates, to adjust the relative position of the virtual image 31 in the visual field 2021, until the eyes 202 see the virtual image 31. When the eye-tracker 41 senses the place where the eyes 202 see is within the virtual image 31, the monitor-base 2 is fixed relative to the main body 1, to fix the position of the virtual image 31 in the visual field 2021. The sight 2022 of the eyes 202 belongs to the state of the head 201, and the eye-tracker 41 mounted on the monitor-base 2 can face the eyes 202, therefore, by monitoring the sight 2022 of the eyes 202, it is able to obtain the position where the sight 2022 locates in the visual field 2021 directly. When the position where the eyes 202 see is beyond the virtual image 31, adjusting the angle of monitor 3, so that the virtual image 31 moves to the position where the eyes 202 see. When the position where the eyes 202 see is within the virtual image 31, the angle of the monitor 3 is maintained, so that the eyes 202 continue to see the virtual image 31. In some embodiments, the eye-tracker 41 includes a camera set at the monitor-base 2 and facing the eyes 202, the camera can track the sight 2022 of the eyes 202 according to the characteristic changes of the eyeball and the periphery of the eyeball, or the camera tracks the sight 2022 of the eyes 202 according to the change of the iris angle. The camera can also actively project infrared light beams to the iris to extract features to track the sight 2022 of the eyes 202.

As shown in FIG. 1 to FIG. 2, in some embodiments, there is an area between the virtual image 31 and the lower boundary of the visual field 2021. When the eye-tracker 41 senses that the sight 2022 deflects downward to a certain angle, causing the sight 2022 falls into the area between the virtual image 31 and the lower boundary of the visual field 2021, the monitor-base 2 rotates so that the lower edge of the monitor 3 becomes closer to the eyes 202. Thus, the angle of the monitor 3 relative to the eyes 202 is adjusted, so that the virtual image 31 locates within the sight 2022 of the eyes 202 again. Usually, when the user 200 needs to see something downward, the user 200 prefers to turn the eyes 202 downward than to lower the head 201. However, when the user 200 needs to see something on the left, right, or upward, the user 200 prefers to turn the head 201.

As shown in FIG. 1 to FIG. 2, in some embodiments, the head-mounted device 100 further includes a control module and a driver module. The control module and the driver module are mounted on the main body 1 or on the monitor-base 2. The control module is connected to the eye-tracker 41 and the driver module. The control module is used for receiving and analyzing a signal generated by the eye-tracker 41 about the position where the eyes 202 see. The driver module is used for moving the monitor-base 2 relative to the main body 1. When the control module judges that the sight 2022 where the eyes 202 see is beyond the virtual image 31, the control module controls the driver module to rotate the monitor-base 2 relative to the main body 1. When the control module judges that the sight 2022 where the eyes 202 see is within the virtual image 31, the control module controls the driver module to maintain the position of the monitor-base 2 relative to the main body 1. The eye-tracker 41 monitors the position where the eyes 202 see and converts it into a signal and transmits it to the control module, the control module can analyze the signal generated by the eye-tracker 41 and judge if the position where the eyes 202 see is beyond the virtual image 31, then, the control module controls the driver module to rotate the monitor-base 2, making the monitor-base 2 rotate or remain fixed, so automatically complete the coincidence calibration of the virtual image 31 and the sight 2022 of the eyes 202. In some embodiments, the control module is electrically connected to the eye-tracker 41 and the driver module, to realize signal transmission.

In some embodiments, the control module includes but is not limited to SoC (System on Chip) chips.

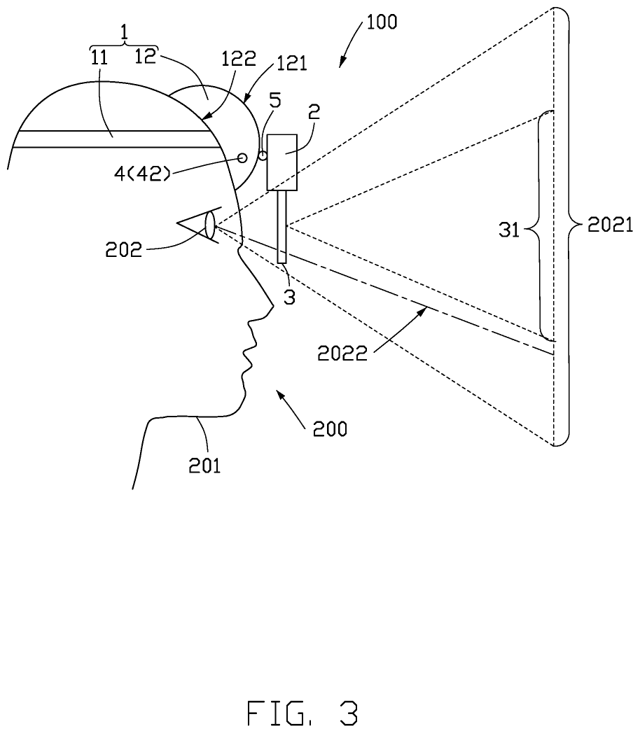

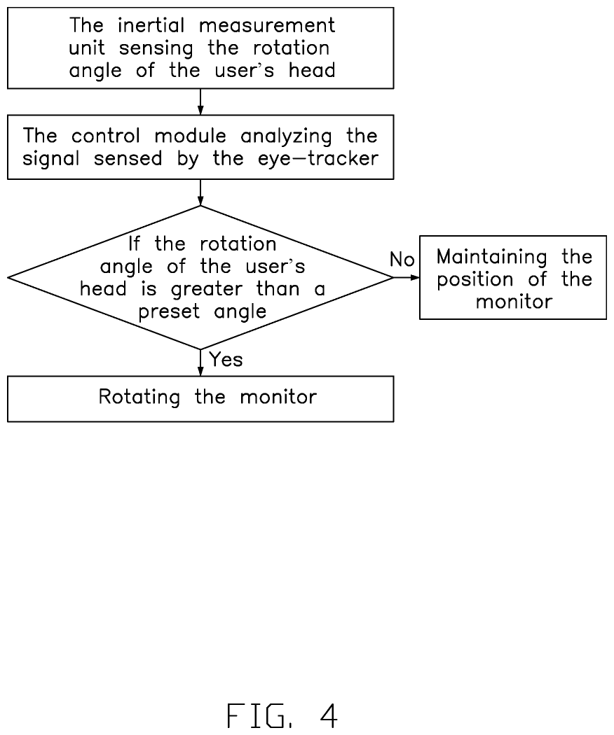

As shown in FIG. 3 to FIG. 4, in some embodiments, the sensor 4 senses the state of the head 201 by sensing the rotation of the head 201. The sensor 4 includes an inertial measurement unit 42. The inertial measurement unit 42 is mounted on the main body 1. The inertial measurement unit 42 is used for measuring a rotating angle of the head 201. When the inertial measurement unit 42 measures that the head 201 rotates by an angle exceeding the preset angle from the initial position of the head 201, the monitor-base 2 rotates, to adjust the relative position of the virtual image 31 in the visual field 2021. When the inertial measurement unit 42 measures that the head 201 rotates by an angle not exceeding the preset angle from the initial position of the head 201, the monitor-base 2 maintains fixed to fix the main body 1, so the virtual image 31 maintains fixed in the visual field 2021. The rotation of the head 201 belongs to the state of the head 201, the inertial measurement unit 42 is mounted on the main body 1, and the main body 1 is fixed relative to the head 201, so the inertial measurement unit 42 can measure the three-axis attitude angle and acceleration of the head 201, thereby obtaining the rotation angle of the head 201. When the head 201 rotates, the eyes 202 will also rotate accordingly, so the position of the sight 2022 of the eyes 202 can be judged by monitoring the rotation angle of the head 201. Therefore, the position where the sight 2022 of the eyes 202 locates in the visual field 2021 can be obtained indirectly. When the position where the eyes 202 see is beyond the virtual image 31, adjusting the angle of the monitor 3, so that the virtual image 31 moves to the position where the eyes 202 see. When the position where the eyes 202 see is within the virtual image 31, the angle of the monitor 3 is maintained, so that the eyes 202 continue to see the virtual image 31. In some embodiments, the inertial measurement unit 42 is an IMU device. The IMU device includes three single-axis accelerometers and three single-axis gyroscopes. It measures the angular velocity and acceleration of the head 201 in the three-dimensional space and calculates the rotation angle of the head 201.

As shown in FIG. 3 to FIG. 4, in some embodiments, there is an area between the virtual image 31 and the lower boundary of the visual field 2021. When the inertial measurement unit 42 senses that the head 201 rotates downward to a certain angle, causing that the sight 2022 falls into the area between the virtual image 31 and the lower boundary of the visual field 2021, the monitor-base 2 rotates so that the lower edge of the monitor 3 becomes closer to the eyes 202. Thus, the angle of the monitor 3 relative to the eyes 202 is adjusted, so that the virtual image 31 locates within the sight 2022 of the eyes 202 again. Usually, when the user 200 needs to see something on the left, right, downward, or upward, the user 200 prefers to turn the head 201 and the eyes 202 at the same time. For example, when the user 200 turns the head 201 down to see the ground, the eyes 202 may incline downward by about 15°, then the monitor-base 2 moves the monitor 3 to move downward the virtual image 31, to offset the downward angle deviation about 15° of the eyes 202; when the user 200 looks straight ahead, the eyes 202 may incline downward by about 5°, then the monitor-base 2 moves the monitor 3 to move downward the virtual image 31, to offset the downward angle deviation about 5° of the eyes 202.

As shown in FIG. 3 to FIG. 4, in some embodiments, the control module is connected to the inertial measurement unit 42 and the driver module. The control module is used for receiving and analyzing a signal generated by the inertial measurement unit 42 about the rotation of the head 201. When the control module judges that the rotation angle of the head 201 is greater than a preset angle, the control module controls the driver module to rotate the monitor-base 2 relative to the main body 1. When the control module judges that the rotation angle of the head 201 is smaller than the preset angle, the control module controls the driver module to maintain the position of the monitor-base 2 relative to the main body 1. The inertial measurement unit 42 monitors the rotation angle of the head 201 and converts it into a signal and transmits it to the control module, the control module can analyze the signal generated by the inertial measurement unit 42 and obtain the rotation angle of the eyes 202 based on the rotation angle of the head 201, so to judge if the position where the eyes 202 see is beyond the virtual image 31, then, the control module controls the driver module to rotate the monitor-base 2, making the monitor-base 2 rotate or remain fixed, so automatically complete the coincidence calibration of the virtual image 31 and the sight 2022 of the eyes 202.

In some other embodiments, the state of the head 201 may further include the sound heard by the user's ears. After hearing the sound by the ears, the user 200 will look at the position where the sound is generated, causing the eyes 202 to rotate. Then the monitor-base 2 rotates the monitor 3 to adjust the relative position of the virtual image 31 in the visual field 2021.

As shown in FIG. 1 and FIG. 3, in some embodiments, the amount of the monitor-base 2 is one, the monitor 3 includes a left-monitor and a right-monitor, each of the left-monitor and the right-monitor is used for displaying the virtual image 31 to a left eye of the eyes 202 and a right eye of the eyes 202, respectively. When the monitor-base 2 rotates, the left-monitor and the right-monitor rotate synchronously, the rotation angles of the left-monitor and the right-monitor are the same, or the monitor-base 2 moves the left-monitor and the right-monitor independently, the rotation angles of the left-monitor and the right-monitor are different. For example, the rotation angles of the two eyes 202 are the same, the monitor-base 2 drives the left-monitor and the right-monitor to move at the same time, the angles between the two monitors and their corresponding eyes 202 change synchronously, the angles between the two monitors and their corresponding eyes 202 are equal, so the positions of the sight 2022 of the two eyes 202 coincide with the virtual image 31 at the same time, avoiding the situation where one eye 202 can see the virtual image 31 but the other eye 202 cannot see the virtual image 31.

In some embodiments, when the user 200 is standing upright and looking straight ahead and wearing the head-mounted device 100, the rotating shaft 5 is higher than the eyes 202 and the monitor 3 in the vertical direction.

In some embodiments, the head-mounted device 100 further includes a rail and a slider, one of the main body 1 and the monitor-base 2 comprises a bevel 121, the slider is mounted on another one of the main body 1 and the monitor-base 2, the rail extends along the bevel 121, the slider is slidable along the rail, so the monitor-base 2 is slidable relative to the main body 1, to adjust the relative angle of the monitor 3 to the eyes 202. Through the cooperation of slider and rail, the monitor-base 2 is slidable relative to the main body 1, the sliding direction of the monitor-base 2 is the extension direction of the rail, and the rail extends along the bevel 121 on the main body 1, which allows the monitor-base 2 to rotate relative to the main body 1 while sliding, and the monitor 3 is fixed relative to the monitor-base 2, and the position of the main body 1 relative to the eyes 202 is fixed, so the angle of the monitor 3 relative to the eyes 202 can be changed to adjust the position of the virtual image 31 in the visual field 2021, so that the virtual image 31 is located in the sight 2022 of the eyes 202.

As shown in FIG. 1 and FIG. 3, in some embodiments, the main body 1 includes a headband 11. The headband 11 can be mounted around the head 201. The monitor-base 2 is movable relative to the headband 11. The headband 11 is mounted around the head 201, so the headband 11 can be blocked by the head 201 in multiple directions to avoid movement, thereby keeping the headband 11 fixed relative to the head 201. When the monitor-base 2 rotates relative to the headband 11, the monitor-base 2 rotates relative to the head 201, to adjust the relative angle of the monitor 3 to the eyes 202, so that the virtual image 31 is located on the sight 2022 of the eyes 202.

As shown in FIG. 1 and FIG. 3, in some embodiments, the main body 1 further includes a pad 12. The pad 12 is mounted on the headband 11. The pad 12 has a curved surface 122, and the curved surface 122 contacts the forehead of the user 200, to fix the headband 11 to the head 201. The monitor-base 2 is movable relative to the pad 12. Because the headband 11 is equipped with the pad 12, the headband 11 is mounted around the head 201, and the curved surface 122 of the pad 12 contacts the forehead of the user 200, the stability of the relative positions of the headband 11, the pad 12 and the head 201 can be enhanced. When the monitor-base 2 rotates relative to the pad 12 to adjust the relative angle of the monitor 3 to the eyes 202, the angle between the monitor 3 and the eyes 202 cannot be affected by the movements of the headband 11 and the pad 12 relative to the head 201, to ensure that the monitor-base 2 drives the monitor 3 to rotate stably, so to stabilize the position of the virtual image 31.

As shown in FIG. 1, the head-mounted device 100 is an augmented reality device.

When the eyes 202 see the virtual image 31, the head-mounted device 100 defines that the head 201 is positioned in a first position, and the sensor 4 detects a first state of the head 201. When the head 201 is moved to a second position which is different from the first position, and the sensor 4 detects a second state of the head 201. Then the monitor 3 is rotated by the monitor-base 2 according to the second state, to adjust a relative angle of the monitor 3 until the eyes 202 see the virtual image 31.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A head-mounted device comprising:
a main body configured for being worn over a head of a user;
a monitor-base movably mounted on the main body;
at least one monitor mounted on the monitor-base and configured for displaying a virtual image; and
a sensor mounted on the main body or the monitor-base, the sensor configured for detecting a state of the head,
wherein when an area of the virtual image is smaller than a visual field of the user, the at least one monitor is movable by moving the monitor-base relative to the main body according to the state of the head, detected by the sensor, to adjust a relative angle of the at least one monitor to eyes of the user such that a relative position of the virtual image in the visual field is adjusted, the visual field being a maximum area that is visible by the eyes.

2. The head-mounted device of claim 1, wherein the sensor senses the state of the head by sensing the position of the eyes, the sensor comprises an eye-tracker mounted on the monitor-base, and the eye-tracker is configured for tracking a position of the eyes to sense where the eyes see in the visual field;
when the eye-tracker senses the place where the virtual image is not visible by the eyes, the monitor-base moves the at least one monitor to adjust the relative position of the virtual image in the visual field until the virtual image is visible to the eyes.

3. The head-mounted device of claim 2 further comprising a control module; and a driver module, wherein the control module and the driver module are mounted on the main body or on the monitor-base, the control module is connected to the eye-tracker and the driver module and configured for receiving and analyzing a signal generated by the eye-tracker about the position where the eyes see, the driver module is configured for moving the monitor-base relative to the main body.

4. The head-mounted device of claim 1, wherein the sensor senses the state of the head by sensing a rotation of the head, the sensor comprises an inertial measurement unit mounted on the main body, the inertial measurement unit is configured for measuring a rotating angle of the head, when the rotating angle measured by the inertial measurement unit is greater than a preset angle, the monitor-base moves to adjust the relative position of the virtual image in the visual field.

5. The head-mounted device of claim 4 further comprising a control module; and a driver module, wherein the control module and the driver module is mounted on the main body or on the monitor-base, the control module is connected to the inertial measurement unit and the driver module and configured for receiving and analyzing a signal generated by the inertial measurement unit about the rotating angle measured by the inertial measurement unit, the driver module is configured for moving the monitor-base relative to the main body.

6. The head-mounted device of claim 1 further comprising a rotating shaft, wherein the monitor-base is connected to the main body by the rotating shaft such that the monitor-base is rotatable relative to the main body, to adjust the relative angle of the at least one monitor to the eyes.

7. The head-mounted device of claim 6, wherein the at least one monitor comprises a left-monitor and a right-monitor, each of the left-monitor and the right-monitor is configured for displaying the virtual image to a left eye of the eyes and a right eye of the eyes, respectively, the monitor-base moves the left-monitor and the right-monitor synchronously or independently.

8. The head-mounted device of claim 1 further comprising a rail and a slider, one of the main body and the monitor-base comprises a bevel, the slider is mounted on another one of the main body and the monitor-base, the rail extends along the bevel, the slider is slidable along the rail, the monitor-base is slidable relative to the main body to adjust the relative angle of the at least one monitor to the eyes.

9. The head-mounted device of claim 1, wherein the main body comprises a headband, the monitor-base is connected to the headband and is rotatable relative to the monitor-base.

10. The head-mounted device of claim 9, wherein the main body further comprises a pad, the pad is connected to the headband, the pad defines a curved surface, the curved surface is configured for contacting a forehead of the user to fix the headband to the head, the monitor-base is rotatably connected to the pad.

11. An augmented reality device comprising:
a main body configured for being worn over a head of a user;
a monitor-base movably mounted on the main body;
at least one monitor mounted on the monitor-base and configured for displaying a virtual image; and
a sensor mounted on the main body or the monitor-base, the sensor configured for detecting a state of the head,
wherein when an area of the virtual image is smaller than a visual field of the user, the at least one monitor is movable by moving the monitor-base relative to the main body according to the state of the head, detected by the sensor, to adjust a relative angle of the at least one monitor to eyes of the user such that a relative position of the virtual image in the visual field is adjusted, the visual field being a maximum area that is visible by the eyes.

12. The augmented reality device of claim 11, wherein the sensor senses the state of the head by sensing the position of the eyes, the sensor comprises an eye-tracker mounted on the monitor-base, and the eye-tracker is configured for tracking a position of the eyes to sense where the eyes see in the visual field;
when the eye-tracker senses the place where the virtual image is not visible by the eyes, the monitor-base moves the at least one monitor to adjust the relative position of the virtual image in the visual field until the virtual image is visible to the eyes.

13. The augmented reality device of claim 12 further comprising a control module; and a driver module, wherein the control module and the driver module are mounted on the main body or on the monitor-base, the control module is connected to the eye-tracker and the driver module and configured for receiving and analyzing a signal generated by the eye-tracker about the position where the eyes see, the driver module is configured for moving the monitor-base relative to the main body.

14. The augmented reality device of claim 11, wherein the sensor senses the state of the head by sensing a rotation of the head, the sensor comprises an inertial measurement unit mounted on the main body, the inertial measurement unit is configured for measuring a rotating angle of the head, when the rotating angle measured by the inertial measurement unit is greater than a preset angle, the monitor-base moves to adjust the relative position of the virtual image in the visual field.

15. The augmented reality device of claim 14 further comprising a control module; and a driver module, wherein the control module and the driver module is mounted on the main body or on the monitor-base, the control module is connected to the inertial measurement unit and the driver module and configured for receiving and analyzing a signal generated by the inertial measurement unit about the rotating angle measured by the inertial measurement unit, the driver module is configured for moving the monitor-base relative to the main body.

16. The augmented reality device of claim 11 further comprising a rotating shaft, wherein the monitor-base is connected to the main body by the rotating shaft such that the monitor-base is rotatable relative to the main body, to adjust the relative angle of the at least one monitor to the eyes.

17. The augmented reality device of claim 16, wherein the at least one monitor comprises a left-monitor and a right-monitor, each of the left-monitor and the right-monitor is configured for displaying the virtual image to a left eye of the eyes and a right eye of the eyes, respectively, the monitor-base moves the left-monitor and the right-monitor synchronously or independently.

18. The augmented reality device of claim 11 further comprising a rail and a slider, one of the main body and the monitor-base comprises a bevel, the slider is mounted on another one of the main body and the monitor-base, the rail extends along the bevel, the slider is slidable along the rail, the monitor-base is slidable relative to the main body to adjust the relative angle of the at least one monitor to the eyes.

19. The augmented reality device of claim 11, wherein the main body comprises a headband, the monitor-base is connected to the headband and is rotatable relative to the monitor-base.

20. A head-mounted device comprising:
a main body;
a monitor-base;
a monitor located on the monitor-base, the monitor configured for displaying a virtual image; and
a sensor located on the monitor-base;
wherein when the user's head is positioned in a first position, the sensor detects a first state of the user's head, and when the user's head is positioned in a second position, the sensor detects a second state of the user's head; the first position is different from the second position; the monitor is rotated according to the second state to adjust a relative angle of the monitor to the user's eyes.
